(19) United States
(12) Patent Application Publication
(10) Pub. No.: US 2025/0274973 A1
(43) Pub. Date: Aug. 28, 2025

(54) Configuring Multiple Measurement Gaps

(71) Applicant: APPLE INC., Cupertino, CA (US)

(72) Inventors: Qiming Li, Beijing (CN); Xiang Chen, Campbell, CA (US); Yang Tang, San Jose, CA (US); Manasa Raghavan, Sunnyvale, CA (US); Dawei Zhang, Saratoga, CA (US); Jie Cui, San Jose, CA (US); Yuqin Chen, Beijing (CN); Haijing Hu, Los Gatos, CA (US)

(21) Appl. No.: 18/859,851

(22) PCT Filed: Jun. 29, 2022
(86) PCT No.: PCT/CN2022/102193

§ 371 Date: Oct. 24, 2024

(51) Int. Cl. H04W 74/04; H04W 8/22; H04W 74/08

(52) U.S. Cl. CPC H04W 74/04; H04W 8/22; H04W 74/0875

(57) ABSTRACT

This disclosure relates to techniques for configuring multiple measurement gaps in a wireless communication system. A wireless device can provide wireless device capability information indicating measurement gap handling capability for the wireless device to a cellular base station. The capability information can indicate any or all of a supported maximum number of active measurement gaps for the wireless device, a preferred maximum measurement gap length overhead for the wireless device, or support for associating functionality with measurement gaps by the wireless device, among various possibilities. The cellular base station can provide measurement gap configuration information to the wireless device, which can configure one or multiple measurement gaps for the wireless device.

### PRIORITY INFORMATION

This application is a national stage entry of PCT Application No. PCT/CN2022/102193, entitled “Configuring Multiple Measurement Gaps,” filed Jun. 29, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for configuring multiple measurement gaps in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include LTE, LTE Advanced (LTE-A), NR, HSPA, IEEE 802.11 (WLAN or Wi-Fi), BLUETOOTH™, ultra-wideband (UWB), etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for configuring multiple measurement gaps in a wireless communication system.

According to the techniques described herein, it can be possible for a wireless device to provide capability information to a cellular network to inform the network of its gap handling related capabilities, including capabilities relating to with how many gaps the wireless device can handle being configured, and/or with how much gap overhead the wireless device can handle being configured.

The cellular network can use such information to configure the wireless device with one or possibly multiple measurement gaps. It can further be possible to associate certain gap functionality with the configured measurement gap(s). In such a case, the wireless device can perform the gap functionality associated with a measurement gap during that measurement gap.

Additionally, it can be possible to associate multiple gap functionalities with a configured measurement gap, and/or to associate a gap functionality with multiple configured measurement gaps. Techniques are also described herein for handling gap sharing scenarios, for example including configuring different priorities for different gap functionalities, and/or configuring different sharing factors for different gap functionalities. Still further, priority and sharing factor configuration based techniques for handling time domain co-existence between measurement gaps and layer one operations are described herein.

Note that the techniques described herein can be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for configuring multiple measurement gaps in a wireless communication system, according to some embodiments;

FIG. 6 illustrates exemplary aspects of a possible scenario in which association between functionality and measurement gaps can be assigned, according to some embodiments;

FIG. 7 illustrate exemplary aspects of a possible scenario in which a measurement gap can be shared between multiple functionalities, according to some embodiments; and

FIG. 8 is a table illustrating exemplary possible sharing factors that could be used to determine sharing priority for joint measurement gaps, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point

### Terms

The following is a glossary of terms that can appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer system for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or can be stationary or fixed at a certain location. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

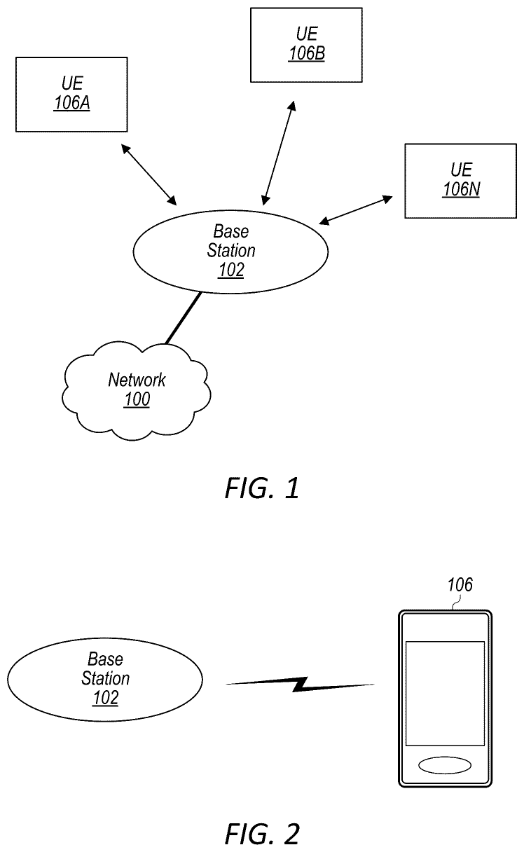

### FIGS. 1 and 2—Exemplary Communication System

FIG. 1 illustrates an exemplary (and simplified) wireless communication system in which aspects of this disclosure can be implemented, according to some embodiments. It is noted that the system of FIG. 1 is merely one example of a possible system, and embodiments can be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices can be referred to herein as a “user equipment” (UE) or UE device. Thus, the user devices 106 are referred to as UEs or UE devices.

The base station 102 can be a base transceiver station (BTS) or cell site, and can include hardware and/or software that enables wireless communication with the UEs 106A through 106N. If the base station 102 is implemented in the context of LTE, it can alternately be referred to as an ‘eNodeB’ or ‘eNB’. If the base station 102 is implemented in the context of 5G NR, it can alternately be referred to as a ‘gNodeB’ or ‘gNB’. The base station 102 can also be equipped to communicate with a network 100 (e.g., a core network of a cellular service provider, a telecommunication network such as a public switched telephone network (PSTN), and/or the Internet, among various possibilities). Thus, the base station 102 can facilitate communication among the user devices and/or between the user devices and the network 100. The communication area (or coverage area) of the base station can be referred to as a “cell.” As also used herein, from the perspective of UEs, a base station can sometimes be considered as representing the network insofar as uplink and downlink communications of the UE are concerned. Thus, a UE communicating with one or more base stations in the network can also be interpreted as the UE communicating with the network.

The base station 102 and the user devices can be configured to communicate over the transmission medium using any of various radio access technologies (RATs), also referred to as wireless communication technologies, or telecommunication standards, such as LTE, LTE-Advanced (LTE-A), LAA/LTE-U, 5G NR, Wi-Fi, UWB, etc.

Base station 102 and other similar base stations operating according to the same or a different cellular communication standard can thus be provided as one or more networks of cells, which can provide continuous or nearly continuous overlapping service to UE 106 and similar devices over a geographic area via one or more cellular communication standards.

Note that a UE 106 can be capable of communicating using multiple wireless communication standards. For example, a UE 106 might be configured to communicate using either or both of a 3GPP cellular communication standard or a 3GPP2 cellular communication standard. In some embodiments, the UE 106 can be configured to perform techniques for configuring multiple measurement gaps in a wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 can be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 can include a processor (processing element) that is configured to execute program instructions stored in memory. The UE 106 can perform any of the method embodiments described herein by executing such stored instructions. Alternatively, or in addition, the UE 106 can include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 can be configured to communicate using any of multiple wireless communication protocols. For example, the UE 106 can be configured to communicate using two or more of LTE, LTE-A, 5G NR, WLAN, UWB, or GNSS. Other combinations of wireless communication standards are also possible.

The UE 106 can include one or more antennas for communicating using one or more wireless communication protocols according to one or more RAT standards. In some embodiments, the UE 106 can share one or more parts of a receive chain and/or transmit chain between multiple wireless communication standards. The shared radio can include a single antenna, or can include multiple antennas (e.g., for multiple-input, multiple-output or “MIMO”) for performing wireless communications. In general, a radio can include any combination of a baseband processor, analog RF signal processing circuitry (e.g., including filters, mixers, oscillators, amplifiers, etc.), or digital processing circuitry (e.g., for digital modulation as well as other digital processing). Similarly, the radio can implement one or more receive and transmit chains using the aforementioned hardware. For example, the UE 106 can share one or more parts of a receive and/or transmit chain between multiple wireless communication technologies, such as those discussed above.

In some embodiments, the UE 106 can include any number of antennas and can be configured to use the antennas to transmit and/or receive directional wireless signals (e.g., beams). Similarly, the BS 102 can also include any number of antennas and can be configured to use the antennas to transmit and/or receive directional wireless signals (e.g., beams). To receive and/or transmit such directional signals, the antennas of the UE 106 and/or BS 102 can be configured to apply different “weight” to different antennas. The process of applying these different weights can be referred to as “precoding”.

In some embodiments, the UE 106 can include separate transmit and/or receive chains (e.g., including separate antennas and other radio components) for each wireless communication protocol with which it is configured to communicate. As a further possibility, the UE 106 can include one or more radios that are shared between multiple wireless communication protocols, and one or more radios that are used exclusively by a single wireless communication protocol. For example, the UE 106 can include a shared radio for communicating using either of LTE or NR, and separate radios for communicating using each of Wi-Fi, UWB, and/or BLUETOOTH™. Other configurations are also possible.

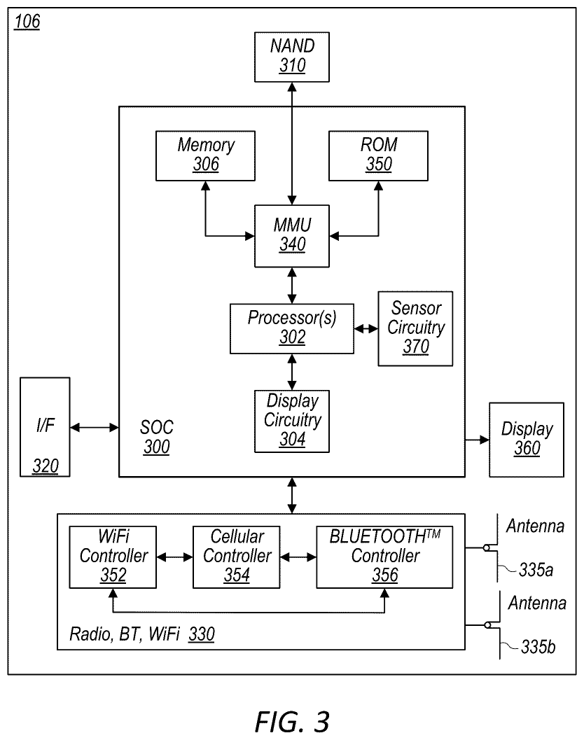

### FIG. 3—Block Diagram of an Exemplary UE Device

FIG. 3 illustrates a block diagram of an exemplary UE 106, according to some embodiments. As shown, the UE 106 can include a system on chip (SOC) 300, which can include portions for various purposes. For example, as shown, the SOC 300 can include processor(s) 302 which can execute program instructions for the UE 106 and display circuitry 304 which can perform graphics processing and provide display signals to the display 360. The SOC 300 can also include sensor circuitry 370, which can include components for sensing or measuring any of a variety of possible characteristics or parameters of the UE 106. For example, the sensor circuitry 370 can include motion sensing circuitry configured to detect motion of the UE 106, for example using a gyroscope, accelerometer, and/or any of various other motion sensing components. As another possibility, the sensor circuitry 370 can include one or more temperature sensing components, for example for measuring the temperature of each of one or more antenna panels and/or other components of the UE 106. Any of various other possible types of sensor circuitry can also or alternatively be included in UE 106, as desired. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 can be configured to perform memory protection and page table translation or set up. In some embodiments, the MMU 340 can be included as a portion of the processor(s) 302.

As shown, the SOC 300 can be coupled to various other circuits of the UE 106. For example, the UE 106 can include various types of memory (e.g., including NAND flash memory 310), a connector interface 320 (e.g., for coupling to a computer system, dock, charging station, etc.), the display 360, and wireless communication circuitry 330 (e.g., for LTE, LTE-A, NR, BLUETOOTH™, Wi-Fi, UWB, GPS, etc.). The UE device 106 can include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 can include fewer or more antennas. Overall, the one or more antennas are collectively referred to as antenna 335. For example, the UE device 106 can use antenna 335 to perform the wireless communication with the aid of radio circuitry 330. The communication circuitry can include multiple receive chains and/or multiple transmit chains for receiving and/or transmitting multiple spatial streams, such as in a multiple-input multiple output (MIMO) configuration. As noted above, the UE can be configured to communicate wirelessly using multiple wireless communication standards in some embodiments.

The UE 106 can include hardware and software components for implementing methods for the UE 106 to perform techniques for configuring multiple measurement gaps in a wireless communication system, such as described further subsequently herein. The processor(s) 302 of the UE device 106 can be configured to implement part or all of the methods described herein, e.g., by executing program instructions stored on a memory medium (e.g., a non-transitory computer-readable memory medium). In other embodiments, processor(s) 302 can be configured as a programmable hardware element, such as an FPGA (Field Programmable Gate Array), or as an ASIC (Application Specific Integrated Circuit). Furthermore, processor(s) 302 can be coupled to and/or can interoperate with other components as shown in FIG. 3, to perform techniques for configuring multiple measurement gaps in a wireless communication system according to various embodiments disclosed herein. Processor(s) 302 can also implement various other applications and/or end-user applications running on UE 106.

In some embodiments, radio 330 can include separate controllers dedicated to controlling communications for various respective RAT standards. For example, as shown in FIG. 3, radio 330 can include a Wi-Fi controller 352, a cellular controller (e.g., LTE and/or LTE-A controller) 354, and BLUETOOTH™ controller 356, and in at least some embodiments, one or more or all of these controllers can be implemented as respective integrated circuits (ICs or chips, for short) in communication with each other and with SOC 300 (and more specifically with processor(s) 302). For example, Wi-Fi controller 352 can communicate with cellular controller 354 over a cell-ISM link or WCI interface, and/or BLUETOOTH™ controller 356 can communicate with cellular controller 354 over a cell-ISM link, etc. While three separate controllers are illustrated within radio 330, other embodiments have fewer or more similar controllers for various different RATs that can be implemented in UE device 106.

Further, embodiments in which controllers can implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

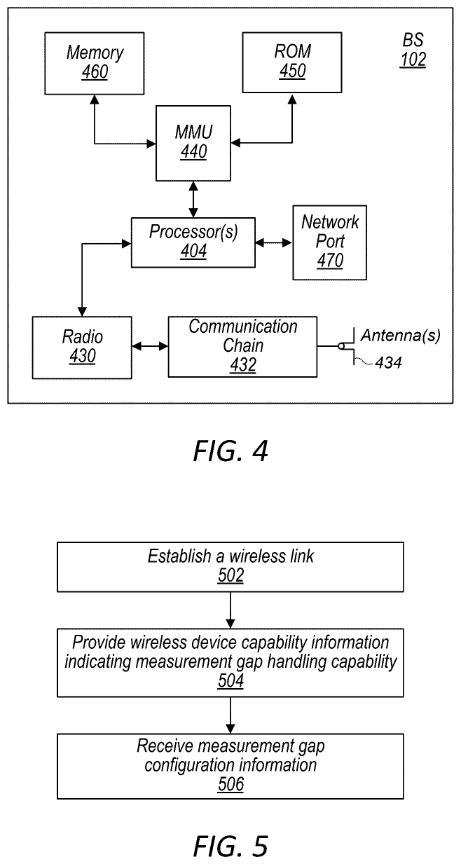

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 can include processor(s) 404 which can execute program instructions for the base station 102. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

The base station 102 can include at least one network port 470. The network port 470 can be configured to couple to a telephone network and provide a plurality of devices, such as UE devices 106, access to the telephone network as described above in FIGS. 1 and 2. The network port 470 (or an additional network port) can also or alternatively be configured to couple to a cellular network, e.g., a core network of a cellular service provider. The core network can provide mobility related services and/or other services to a plurality of devices, such as UE devices 106. In some cases, the network port 470 can couple to a telephone network via the core network, and/or the core network can provide a telephone network (e.g., among other UE devices serviced by the cellular service provider).

In some embodiments, base station 102 can be a next generation base station, e.g., a 5G New Radio (5G NR) base station, or “gNB”. In such embodiments, base station 102 can be connected to a legacy evolved packet core (EPC) network and/or to a NR core (NRC) network. In addition, base station 102 can be considered a 5G NR cell and can include one or more transmission and reception points (TRPs). In addition, a UE capable of operating according to 5G NR can be connected to one or more TRPs within one or more gNBs.

The base station 102 can include at least one antenna 434, and possibly multiple antennas. The antenna(s) 434 can be configured to operate as a wireless transceiver and can be further configured to communicate with UE devices 106 via radio 430. The antenna(s) 434 communicates with the radio 430 via communication chain 432. Communication chain 432 can be a receive chain, a transmit chain or both. The radio 430 can be designed to communicate via various wireless telecommunication standards, including, but not limited to, 5G NR, 5G NR SAT, LTE, LTE-A, UWB, Wi-Fi, etc.

The base station 102 can be configured to communicate wirelessly using multiple wireless communication standards. In some instances, the base station 102 can include multiple radios, which can enable the base station 102 to communicate according to multiple wireless communication technologies. For example, as one possibility, the base station 102 can include an LTE radio for performing communication according to LTE as well as a 5G NR radio for performing communication according to 5G NR. In such a case, the base station 102 can be capable of operating as both an LTE base station and a 5G NR base station. As another possibility, the base station 102 can include a multi-mode radio which is capable of performing communications according to any of multiple wireless communication technologies (e.g., 5G NR and Wi-Fi, 5G NR SAT and Wi-Fi, LTE and Wi-Fi, LTE and UWB, etc.). Other configurations are possible.

As described further subsequently herein, the BS 102 can include hardware and software components for implementing or supporting implementation of features described herein. The processor 404 of the base station 102 can be configured to implement and/or support implementation of part or all of the methods described herein, e.g., by executing program instructions stored on a memory medium (e.g., a non-transitory computer-readable memory medium). Alternatively, the processor 404 can be configured as a programmable hardware element, such as an FPGA (Field Programmable Gate Array), or as an ASIC (Application Specific Integrated Circuit), or a combination thereof. In the case of certain RATs, for example Wi-Fi, base station 102 can be designed as an access point (AP), in which case network port 470 can be implemented to provide access to a wide area network and/or local area network(s), e.g., it can include at least one Ethernet port, and radio 430 can be designed to communicate according to the Wi-Fi standard.

In addition, as described herein, processor(s) 404 can include one or more processing elements. Thus, processor(s) 404 can include one or more integrated circuits (ICs) that are configured to perform the functions of processor(s) 404. In addition, each integrated circuit can include circuitry (e.g., first circuitry, second circuitry, etc.) configured to perform the functions of processor(s) 404.

Further, as described herein, radio 430 can include one or more processing elements. Thus, radio 430 can include one or more integrated circuits (ICs) that are configured to perform the functions of radio 430. In addition, each integrated circuit can include circuitry (e.g., first circuitry, second circuitry, etc.) configured to perform the functions of radio 430.

### Reference Signals

A wireless device, such as a user equipment, can be configured to perform a variety of tasks that include the use of reference signals (RS) provided by one or more cellular base stations. For example, initial access and beam measurement by a wireless device can be performed based at least in part on synchronization signal blocks (SSBs) provided by one or more cells provided by one or more cellular base stations within communicative range of the wireless device. Another type of reference signal commonly provided in a cellular communication system can include channel state information (CSI) RS. Various types of CSI-RS can be provided for tracking (e.g., for time and frequency offset tracking), beam management (e.g., with repetition configured, to assist with determining one or more beams to use for uplink and/or downlink communication), and/or channel measurement (e.g., CSI-RS configured in a resource set for measuring the quality of the downlink channel and reporting information related to this quality measurement to the base station), among various possibilities. For example, in the case of CSI-RS for CSI acquisition, the UE can periodically perform channel measurements and send channel state information (CSI) to a BS. The base station can then receive and use this channel state information to determine an adjustment of various parameters during communication with the wireless device. In particular, the BS can use the received channel state information to adjust the coding of its downlink transmissions to improve downlink channel quality.

In many cellular communication systems, the base station can transmit some or all such reference signals (or pilot signals), such as SSB and/or CSI-RS, on a periodic basis. In some instances, aperiodic reference signals (e.g., for aperiodic CSI reporting) can also or alternatively be provided.

As a detailed example, in the 3GPP NR cellular communication standard, the channel state information fed back from the UE based on CSI-RS for CSI acquisition can include one or more of a channel quality indicator (CQI), a precoding matrix indicator (PMI), a rank indicator (RI), a CSI-RS Resource Indicator (CRI), a SSBRI (SS/PBCH Resource Block Indicator, and a Layer Indicator (LI), at least according to some embodiments.

The channel quality information can be provided to the base station for link adaptation, e.g., for providing guidance as to which modulation & coding scheme (MCS) the base station should use when it transmits data. For example, when the downlink channel communication quality between the base station and the UE is determined to be high, the UE can feed back a high CQI value, which can cause the base station to transmit data using a relatively high modulation order and/or a low channel coding rate. As another example, when the downlink channel communication quality between the base station and the UE is determined to be low, the UE can feed back a low CQI value, which can cause the base station to transmit data using a relatively low modulation order and/or a high channel coding rate.

PMI feedback can include preferred precoding matrix information, and can be provided to a base station in order to indicate which MIMO precoding scheme the base station should use. In other words, the UE can measure the quality of a downlink MIMO channel between the base station and the UE, based on a pilot signal received on the channel, and can recommend, through PMI feedback, which MIMO precoding is desired to be applied by the base station. In some cellular systems, the PMI configuration is expressed in matrix form, which provides for linear MIMO precoding. The base station and the UE can share a codebook composed of multiple precoding matrixes, where each MIMO precoding matrix in the codebook can have a unique index. Accordingly, as part of the channel state information fed back by the UE, the PMI can include an index (or possibly multiple indices) corresponding to the most preferred MIMO precoding matrix (or matrixes) in the codebook. This can enable the UE to minimize the amount of feedback information. Thus, the PMI can indicate which precoding matrix from a codebook should be used for transmissions to the UE, at least according to some embodiments.

The rank indicator information (RI feedback) can indicate a number of transmission layers that the UE determines can be supported by the channel, e.g., when the base station and the UE have multiple antennas, which can enable multi-layer transmission through spatial multiplexing. The RI and the PMI can collectively allow the base station to know which precoding needs to be applied to which layer, e.g., depending on the number of transmission layers.

In some cellular systems, a PMI codebook is defined depending on the number of transmission layers. In other words, for R-layer transmission, N number of Nₜ×R matrixes can be defined (e.g., where R represents the number of layers, Nₜ represents the number of transmitter antenna ports, and N represents the size of the codebook). In such a scenario, the number of transmission layers (R) can conform to a rank value of the precoding matrix (Nₜ×R matrix), and hence in this context R can be referred to as the “rank indicator (RI)”.

Thus, the channel state information can include an allocated rank (e.g., a rank indicator or RI). For example, a MIMO-capable UE communicating with a BS can include four receiver chains, e.g., can include four antennas. The BS can also include four or more antennas to enable MIMO communication (e.g., 4×4 MIMO). Thus, the UE can be capable of receiving up to four (or more) signals (e.g., layers) from the BS concurrently. Layer to antenna mapping can be applied, e.g., each layer can be mapped to any number of antenna ports (e.g., antennas). Each antenna port can send and/or receive information associated with one or more layers. The rank can include multiple bits and can indicate the number of signals that the BS can send to the UE in an upcoming time period (e.g., during an upcoming transmission time interval or TTI). For example, an indication of rank 4 can indicate that the BS will send 4 signals to the UE. As one possibility, the RI can be two bits in length (e.g., since two bits are sufficient to distinguish 4 different rank values). Note that other numbers and/or configurations of antennas (e.g., at either or both of the UE or the BS) and/or other numbers of data layers are also possible, according to various embodiments.

### FIG. 5—Configuring Multiple Measurement Gaps

Cellular communication systems can commonly support provision of scheduling gaps that can be used for a variety of purposes. Such gaps can be referred to as “measurement gaps,” at least according to some embodiments, for example since performing serving cell and/or neighbor cell measurements can be a common operation/activity performed during measurement gaps. As cellular communication technology continues to develop, new purposes for gaps have been and will likely continue to be introduced, such that gap configuration and management in general is an area of increasing interest. In particular, with many possible gap functionalities that can be performed during measurement gaps, providing techniques for configuring multiple measurement gaps and for handling coexistence of different gap functionalities can be useful, at least according to some embodiments.

Thus, it can be beneficial to specify techniques for supporting configuring multiple measurement gaps. To illustrate one such set of possible techniques, FIG. 5 is a flowchart diagram illustrating a method for configuring multiple measurement gaps in a wireless communication system, at least according to some embodiments.

Aspects of the method of FIG. 5 can be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device can be configured to cause the device to perform any combination of the illustrated method elements and/or other method elements.

Note that while at least some elements of the method of FIG. 5 are described in a manner relating to the use of communication techniques and/or features associated with 3GPP and/or NR specification documents, such description is not intended to be limiting to the disclosure, and aspects of the method of FIG. 5 can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method of FIG. 5 can operate as follows.

In 502, the wireless device can establish a wireless link with a cellular base station. According to some embodiments, the wireless link can include a cellular link according to 5G NR. For example, the wireless device can establish a session with an AMF entity of the cellular network by way of one or more gNBs that provide radio access to the cellular network. As another possibility, the wireless link can include a cellular link according to LTE. For example, the wireless device can establish a session with a mobility management entity of the cellular network by way of an eNB that provides radio access to the cellular network. Other types of cellular links are also possible, and the cellular network can also or alternatively operate according to another cellular communication technology, according to various embodiments.

Establishing the wireless link can include establishing a RRC connection with a serving cellular base station, at least according to some embodiments. Establishing the first RRC connection can include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device can operate in a RRC connected state. In some instances, the RRC connection can also be released (e.g., after a certain period of inactivity with respect to data communication), in which case the wireless device can operate in a RRC idle state or a RRC inactive state. In some instances, the wireless device can perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least according to some embodiments, the wireless device can establish multiple wireless links, e.g., with multiple TRPs of the cellular network, according to a multi-TRP configuration. In such a scenario, the wireless device can be configured (e.g., via RRC signaling) with one or more transmission control indicators (TCIs), e.g., which can correspond to various beams that can be used to communicate with the TRPs. Further, it can be the case that one or more configured TCI states can be activated by media access control (MAC) control element (CE) for the wireless device at a particular time.

In 504, the cellular base station can provide wireless device capability information indicating measurement gap handling capability for the wireless device. At least in some instances, establishing the wireless link(s) can include the wireless device providing the capability information for the wireless device. Alternatively, the wireless device capability information indicating measurement gap handling capability for the wireless device can be provided at a later time. The capability information can be provided by the wireless device based on network inquiry (e.g., a request for capability information indicating measurement gap handling capability for the wireless device) or without any explicit network inquiry (e.g., as part of general wireless capability reporting). In some instances, the measurement gap handling capability (and/or other gap-related capability information for the wireless device) can be provided using wireless device assistance information (e.g., UE assistance information or UAI).

The wireless device capability information indicating measurement gap handling capability can include an indication of a supported maximum number of active gaps for the wireless device, as one possibility. For example, the wireless device can be limited (or can otherwise prefer) to have no more than a certain number of measurement gap patterns configured and activated for the wireless device, e.g., based on wireless device capabilities and/or preferences, and the measurement gap handling capability can correspondingly indicate to the cellular base station to configure no more than that certain number of measurement gap patterns for the wireless device as active at any given time.

As another possibility, the wireless device capability information indicating measurement gap handling capability can include an indication of a preferred or needed maximum gap length overhead based on the active measurement gaps for the wireless device. For example, the wireless device can be limited (or can otherwise prefer) to have no more than a certain proportion of any given measurement gap repetition period occupied by measurement gaps, e.g., based on wireless device capabilities and/or preferences, and the measurement gap handling capability can correspondingly indicate to the cellular base station to configure no more than that certain proportion of any given measurement gap repetition period to be occupied by measurement gaps.

In some embodiments, the wireless device can also or alternatively provide wireless device capability information and/or wireless device assistance information to indicate whether the wireless device is capable of supporting associating functionality with gaps, and/or to indicate which gap functionality or functionalities the wireless device supports associating with gaps. For example, the wireless device can be limited (or can otherwise prefer) to support for certain gap functionalities or features but not others, and the wireless device can provide capability and/or assistance information correspondingly indicating which functionalities the wireless device supports associating with gaps. Note that indication of support for associating a functionality/feature with a gap could be explicitly indicated, or could be implicitly signaled by signaling support by the wireless device for the functionality/feature itself, according to various embodiments.

Note that the capability information provided by the wireless device can also or alternatively include information relating to any of a variety of other types of wireless device capabilities.

In 506, the wireless device can receive measurement gap configuration information from the cellular base station. The cellular base station can configure one gap or multiple gaps for the wireless device. Configuring the gap(s) can include activating one or more gap patterns, which can include one or more gaps of configured or specified length and at configured or specified intervals in each measurement gap repetition period. The gap(s) can be provided in order to support any of various possible gap functionalities and/or features, such as gaps for radio resource management (RRM) use, gaps for multiple universal subscriber identity module (MUSIM) use, pre-configured measurement gaps, positioning (Pos) and/or enhanced positioning (ePos) gaps, non-terrestrial network (NTN) measurement gaps, network controlled small gaps (NCSG), and/or any of various other possible gap functionalities.

In some embodiments, the cellular base station can indicate that certain gap functionality is associated with one or more of the configured gaps. Such an indication can be provided based at least in part on wireless device capability information indicating that the wireless device supports association between gap functionality and gaps, and possibly more particularly indicating that the wireless device supports such association for the gap functionality being associated with a gap by the cellular base station, at least according to some embodiments.

Note that it can be possible for a gap functionality to be associated with multiple measurement gaps, at least in some embodiments. For example, the measurement gap configuration information could associate a gap functionality with multiple measurement gap patterns for the wireless device. Additionally, or alternatively, it can be possible for multiple gap functionalities to be associated with a measurement gap. For example, the measurement gap configuration information could associate multiple functionalities with a measurement gap pattern for the wireless device.

In scenarios in which multiple gap functionalities can be associated with a measurement gap, and/or in which measurement gap patterns are configured such that measurement gaps overlap temporally, it can be useful to provide a mechanism for handling gap sharing. In other words, it can be important to provide techniques for a wireless device to determine which functionality to perform during a gap occasion that is associated with multiple functionalities (e.g., because multiple gap patterns associated with different gap functionalities overlap during the gap occasion, and/or because multiple gap functionalities are associated with the gap pattern of the gap occasion). For example, a scenario could occur in which the measurement gap configuration information configures a first measurement gap pattern associated with a first gap functionality and a second measurement gap pattern associated with a second gap functionality, such that the first measurement gap pattern and the second measurement gap pattern are at least partially overlapping. In such a scenario, the wireless device can be capable of determining whether to prioritize the first gap functionality or the second gap functionality during occasions when a measurement gap in the first measurement gap pattern and a measurement gap in the second measurement gap pattern are at least partially overlapping. As another example, a scenario could occur in which the measurement gap configuration information configures a measurement gap pattern associated with both a first gap functionality and a second gap functionality. In such a scenario, the wireless device can be capable of determining whether to prioritize the first gap functionality or the second gap functionality during gap occasions of the measurement gap pattern.

In some instances, the cellular base station can provide priority or sharing factor information for different gap functionalities to assist the wireless device to determine which gap functionality to prioritize in such scenarios. For example, the wireless device can receive measurement gap functionality priority information from the cellular base station, which can indicate priority values or otherwise indicate the relative priority for different possible gap functionalities, according to some embodiments. In such a scenario, the wireless device can determine which gap functionality to prioritize when multiple gap functionalities share a gap occasion based at least in part on the measurement gap functionality priority information received from the cellular base station. For example, the wireless device can determine to perform the gap functionality with the higher priority during the shared occasions. Note that the priorities for gap functionalities could be static or semi-static (e.g., configured as a fixed value, either permanently or until re-configured), or could be configured to be dynamic. For example, the priority value for a gap functionality could be configured to increase as the time elapsed since the gap functionality was last performed increases, as one possibility. As another example, the priority value for a gap functionality could be configured to increase as the number of gap occasions that have occurred since the gap functionality was last performed increases.

As another example, the wireless device can receive measurement gap functionality sharing factor information from the cellular base station, which can indicate sharing factor values or otherwise indicate what proportions of shared gap occasions should be used for different gap functionalities, according to some embodiments. In such a scenario, the wireless device can determine which gap functionality to prioritize when multiple gap functionalities share a gap occasion based at least in part on the measurement gap sharing factor information received from the cellular base station. For example, the wireless device can determine to perform gap functionalities in accordance with the configured sharing factors during the shared gap occasions for those gap functionalities; thus, in an example scenario in which a first gap functionality has a sharing factor of 0.75 and a second gap functionality has a sharing factor of 0.25, the wireless device can determine to perform the first gap functionality during three out of every four gaps shared between the first gap functionality and the second gap functionality, and to perform the second gap functionality during one out of every four gaps shared between the first gap functionality and the second gap functionality.

Note that it can further be possible to manage co-existence between layer 1 operations and gap functionalities similarly by configuring priority and/or sharing factor information for the layer 1 operations and gap functionalities. For example, it can be possible that one or more layer 1 operations (e.g., radio link monitoring (RLM) measurements, beam failure detection (BFD) measurements, candidate beam detection (CBD) measurements, L1 reference signal received power (RSRP) measurements, L1 signal to interference plus noise ratio (SINR) measurements) conflict with a measurement gap configured by the measurement gap configuration information. In such a scenario, the wireless device can determine that such a conflict exists, and can determine whether to prioritize the layer one operation or the measurement gap configured by the measurement gap configuration information.

In some embodiments, the prioritization decision can be based on priority information indicating relative priorities for L1 operations and gap functionalities, which can be provided from the cellular base station to the wireless device. The priority information can be the same or different for different L1 operations, and can similarly be the same or different for different gap functionalities. In such a scenario, the wireless device can determine whether to prioritize the L1 operation or the gap functionality based at least in part on the priority information received from the cellular base station. Note that the priorities for L1 operations and gap functionalities could be static or semi-static (e.g., configured as a fixed value, either permanently or until re-configured), or could be configured to be dynamic, such as previously described herein.

In some embodiments, the prioritization decision can be based on sharing factor information indicating sharing factors for LI operations and gap functionalities, which can be provided from the cellular base station to the wireless device. The sharing factor can be commonly configured for all L1 operations, or different sharing factors can be configured for different L1 operations. Similarly, the sharing factor for determining how to share gap occasions that conflict with L1 operations for gap functionalities can be commonly configured for all gap functionalities, or different sharing factors can be configured for different gap functionalities. Thus, whether a gap that conflicts with one or more L1 operations is canceled in favor of the L1 operations, or the L1 operation(s) is (are) dropped in favor of performing the gap functionality, can depend on the sharing factors for the L1 operation and gap functionality in conflict.

Note that it can also be possible that priority information and/or sharing factor information for gap functionalities and/or L1 operations could be specified in standard specifications (e.g., 3GPP technical specifications), in which case it can also be possible that the priority information and/or sharing factor information for gap functionalities and/or L1 operations is not provided to the wireless device by the cellular base station. In such a scenario, for example, the wireless device could be pre-provisioned with such information.

Thus, at least according to some embodiments, the method of FIG. 5 can be used to provide a framework according to which a wireless device can be configured with multiple measurement gaps, at least in some instances. As described herein, such a framework can provide effective support for a greater variety of possible gap functionalities, including for coexistence between different gap functionality operations as well as other wireless device operations with potential for relatively nuanced gap sharing management between such operations, at least according to some embodiments.

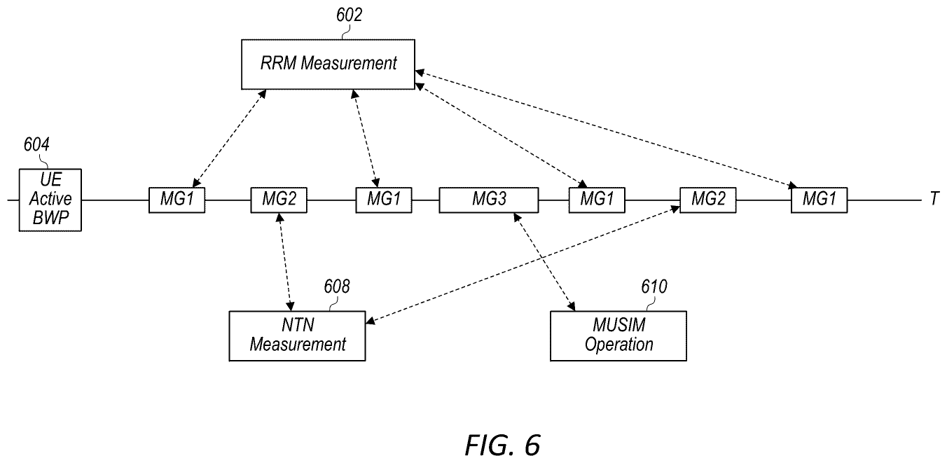

### FIGS. 6-8 and Additional Information

FIGS. 6-8 illustrate further aspects that might be used in conjunction with the method of FIG. 5 if desired. It should be noted, however, that the exemplary details illustrated in and described with respect to FIGS. 6-8 are not intended to be limiting to the disclosure as a whole: numerous variations and alternatives to the details provided herein below are possible and should be considered within the scope of the disclosure.

Measurement gaps can be used in cellular communications to perform measurements on serving cells, neighbor cells, and for a variety of other possible purposes. Measurement gaps and gap related features that can be used in 3GPP communication systems can include, for example, gaps for multiple universal subscriber identity module (MUSIM) use, pre-configured measurement gaps, positioning (Pos) and enhanced positioning (ePos) gaps, non-terrestrial network (NTN) measurement gaps, and/or network controlled small gaps (NCSG). To support such a diversity of potential gap uses/types/functionalities, it can be beneficial to provide techniques for joint configuration of gaps, and more generally for supporting effective gap co-existence in a wireless communication system, at least according to some embodiments.

One possible aspect of such techniques can include supporting UE capability reporting on measurement gap related capabilities for the UE. Such reporting could include reporting the maximum number of configured gap patterns supported by a UE, and/or the maximum measurement gap length overhead supported by a UE. Another possible aspect of such techniques can include supporting association between functionalities and gap IDs. A still further possible aspect of such techniques can include supporting enhanced gap sharing features, such as techniques for handing priority and/or sharing ratio when gap sharing among different functionalities occurs, and/or how to manage possible gap cancelation due to gap occasions colliding with each other and/or with layer 1 (L1) operations such as radio link monitoring measurements, beam failure detection measurements, L1 reference signal received power (RSRP) measurements, and/or other L1 operations. Other techniques are also possible.

The techniques for supporting UE reporting on measurement gap related capabilities can include introducing a new UE capability parameter or information element (e.g., “maxNumberOfGap,”) for reporting the supported maximum number of active gaps for a UE. For a UE supporting per frequency range (FR) gap (e.g., with independentGapConfig as defined in 3GPP 38.306 v.17.0.0 and [per-FR NCSG gap] enabled), the maxNumberOfGap UE capability can be reported per-FR (e.g., separately for each frequency range). In some instances, candidate values could be [2,3,4, . . . ]. Other candidate values are also possible. For a UE that does not support per-FR gap, the maxNumberOfGap UE capability can be reported per-UE, which can apply across all frequency ranges. Similarly, candidate values could be [2,3,4, . . . ], with other candidate values also being possible. Note that the gaps referred to in this UE capability could include any or all of NTN gaps, MUSIM gaps, pre-configured measurement gaps, network controlled short gaps, ePos gaps, uplink gaps, and/or gaps for L1 measurement on neighbor TRP, among various possibilities.

As another possibility, new UE assistance information (UAI) or UE capability information (e.g., “maxMGLOverhead,”) can be introduced for indicating a preferred or supported maximum measurement gap length (MGL) overhead. A MGL overhead parameter can be defined such that it is calculated based on the proportion of measurement gap time in each measurement gap repetition period (MGRP), according to some embodiments; for example, the MGL overhead can be defined as sum(MGLₓ)/sum(MGRPₓ), as one possibility. Note that gap overlapping can already be considered when calculating MGLₓ and MGRPₓ. The MGL overhead capability reporting can be specified as falling within a certain range of values (e.g., between a configured or specified minimum value (based on a theoretical minimum possible amount of overhead in a standard compliant system, which could be 0.39% or another number) and maximum value (which can be less than 100%)), at least in some embodiments. In such a scenario, it can be the case that as long as the MGL overhead is less than the maximum overhead supported (as indicated by the UE capability/assistance information) by the UE, the network can configure any desired measurement gap patterns.

There can be multiple options for when UE capability or assistance information such as the maxNumberOfGap and/or MaxMGLOverhead information is provided to the network. As one possibility, a UE can provide such information after obtaining access to the network (e.g., without the information being explicitly requested, for example as part of initial UE capability reporting). As another possibility, a UE can provide such information in response to network inquiry. After receiving indication from a UE of maxNumberOfGap and/or MaxMGLOverhead information and the gap related features supported by the UE, a network can know which types of gaps and how many gaps can be activated simultaneously within the capability of the UE. The network can be expected to configure gaps for the UE following the UE capability (e.g., not to exceed the supported maximum active gaps and/or the maximum MGL overhead) in such a case. A UE providing such capability and/or assistance information can thus expect the configured gaps not to exceed the reported UE capability; in case the configured gaps do exceed the UE capability, it can be left to UE implementation to choose which gaps to activate among the configured gaps, at least according to some embodiments.

The techniques for supporting association between functionalities and gap IDs can include providing a signaling mechanism for indicating that a certain functionality (or multiple functionalities) is (are) associated with a gap ID (or multiple gap IDs). In some instances, this could include explicitly indicating the functionality of a measurement gap when measurement configuration information activating the measurement gap is provided. As another possibility, certain measurement gaps could be pre-configured (e.g., in higher layer signaling and/or in broadcast system information), or specified (e.g., in 3GPP technical specifications), as being associated with certain functionality, such that indication of the functionality of a measurement gap could be implied when measurement configuration information activating the measurement gap is provided.

FIG. 6 illustrates exemplary aspects of a possible scenario in which association between functionality and measurement gaps can be assigned, according to some embodiments. In the illustrated scenario, a first measurement gap pattern (“MG1”) can be configured for radio resource management (RRM) measurement 602 for a UE active bandwidth part 604. Additionally, a second measurement gap pattern (“MG2”) can be configured for NTN measurement 608 for the UE active bandwidth part 604, and a third measurement gap pattern (“MG3”) can be configured for MUSIM operation for the UE active bandwidth part 610.

In some embodiments, a UE that supports such association can indicate its supported/preferred association to the network. Such an indication can be provided using new UE capability reporting on support by the UE for association between functionality and measurement gaps. As another possibility, such an indication can be provided using new UE assistance information reporting on support by the UE for association between functionality and measurement gaps. In some instances, it can be possible that a UE supports association between functionality and measurement gaps for some (e.g., supported) types of functionality but not for other (e.g., unsupported) types of functionality. In such a scenario, the UE capability information and/or UE assistance information can indicate this more particularly, at least in some embodiments. As another possibility, such support (or lack of support) for association between certain features/functionalities and gaps can be implied based on other information (e.g., UE capability information indicating support or lack of support for those features/functionalities), according to some embodiments.

There can be multiple options for when UE capability or assistance information indicating support for association between functionality and measurement gaps is provided to the network. As one possibility, a UE can provide such information after obtaining access to the network (e.g., without the information being explicitly requested, for example as part of initial UE capability reporting). As another possibility, a UE can provide such information in response to network inquiry. After receiving indication from a UE of support for such association by the UE, a network can know which associations between measurement gaps and functionality are within the capability of the UE. The network can be expected to configure gaps for the UE following the UE capability (e.g., to provide association between functionalities and measurement gaps, based on the UE capability of support of the features and the corresponding association). For functionality for which a UE does not support association between the functionality and gap (e.g., due to early implementation) it can be left to the UE to determine within which gap(s) to operate the functionality, at least according to some embodiments.

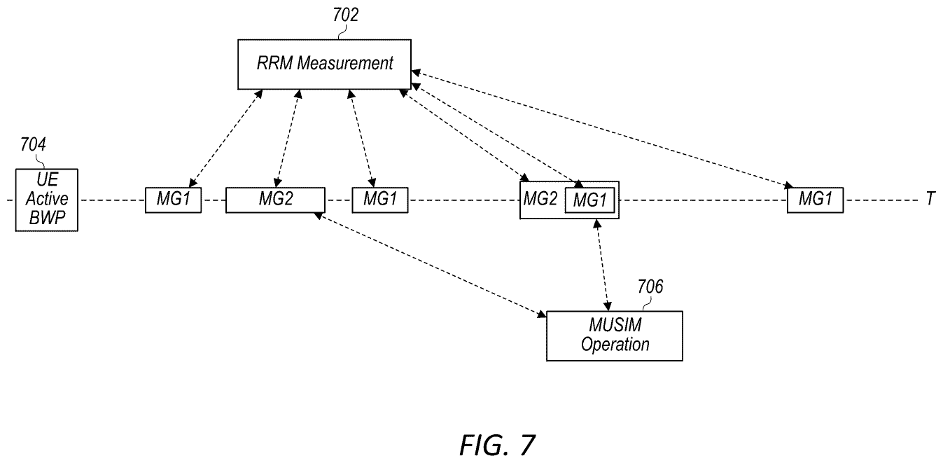

As more gaps can potentially be activated simultaneously for different functionalities, it can be possible that gap collisions (e.g., in time domain) between different patterns (for the same or different functionality) are increasingly likely to occur. Accordingly, it can be beneficial, at least in some instances, to provide techniques for gap sharing in case of such a collision. FIG. 7 illustrate exemplary aspects of a possible scenario in which a measurement gap can be shared between multiple functionalities, according to some embodiments. As shown, in the illustrated scenario, both a first measurement gap pattern (“MG1”) and a second measurement gap pattern (“MG2”) can be configured for RRM measurement 702 for a UE active bandwidth part 704. Additionally, the second measurement gap pattern can also be configured for MUSIM operation 706. Thus, in this example, MG2 gaps can be shared between multiple functionalities, and MG1 and MG2 can further collide during one occasion of each measurement gap repetition period.

There can be multiple options for how a UE handles sharing gaps between different functionalities in such a scenario and/or in other scenarios in which gap collisions and/or associations between multiple functionalities and a measurement gap pattern occur. As one possibility, priority can be introduced for functionality, such that different functionalities have different priority levels, and the functionality with the higher priority can be performed during a shared gap. For example, in the scenario if FIG. 7, if the priority for RRM measurement is configured as 3 while the priority for MUSIM operation is 1 (e.g., RRM has higher priority), for overlapped gap occasions, the UE can perform RRM measurement and drop the MUSIM operation. The priority information for the functionalities can be provided via RRC signaling, e.g., together with measurement related configuration information, at least as one possibility.

If desired, it can be possible that the priority for a given functionality can be configured to include a fixed component and a dynamic component. As one such possibility, the fixed component can be determined based on priority information for functionalities that is provided via RRC signaling, and the dynamic component can depend on how often operation for the functionality is dropped in favor of other functionalities. For example, the dynamic priority component for a given functionality can be incremented by one whenever operation for the functionality is dropped in favor of another functionality during a shared gap, and can be reset to 0 whenever operation for the functionality is performed during a shared gap while operation for another functionality is dropped. Such a scheme can allow for operations with a low baseline priority to be performed occasionally even if their gaps are always shared with higher priority functionalities.

As another possibility, a sharing factor can be introduced among functionalities. The sharing factor could be provided via RRC signaling, as one possibility. The sharing factor can indicate the proportion of shared gap occasions that are used for each of the functionalities sharing the gap, according to some embodiments. For example, for a gap shared between RRM measurement and MUSIM operation, with a 75% (0.75) sharing factor for RRM measurement and a 25% (0.25) sharing factor for MUSIM operation, a UE can perform RRM measurement on 75% of the shared gap occasions and MUSIM operation on 25% of the shared gap occasions.

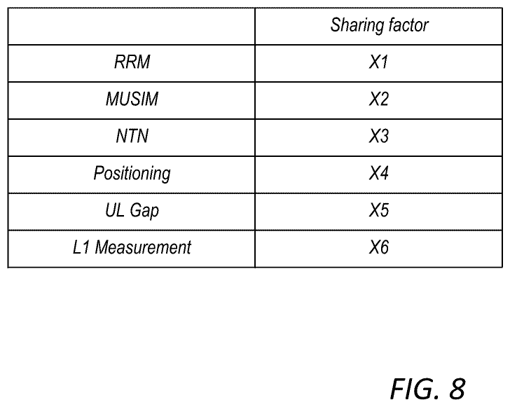

FIG. 8 is a table illustrating exemplary possible sharing factors that could be used to determine sharing priority for joint measurement gaps, according to some embodiments. In some instances, the sharing factors can be configured such that the total sum of all the sharing factors is equal to 1 (e.g., X1+X2+X3+X4+X5+X6=1, in the scenario of FIG. 8). It can also be possible that a sharing factor (X) value can be set to 0, e.g., if the corresponding functionality is not configured/supported. Such a sharing factor table could be provided for each combination of functionalities that are configured in a measurement gap, in some instances. As another possibility, one sharing factor table can be provided, and sharing factor values in the table can be adjusted as needed to compensate for any functionalities with non-zero sharing factor values in the table that do not share a given measurement gap pattern when determining how to share the measurement gap pattern between the functionalities. For example, any non-zero sharing factor values for functionalities that do not share a given measurement gap can be ignored, and the remaining sharing factor values for functionalities that do share the measurement gap can be normalized such that their sum is equal to 1, for the purpose of determining gap sharing factors for that particular measurement gap, at least as one possibility. Other techniques for using sharing factors to configure proportional use of shared gaps between different functionalities are also possible.

Techniques for handling collisions between gaps and L1 operation can also be useful, in particular in view of the potential for an increasing number of gaps that can potentially be activated simultaneously for different functionalities, at least according to some embodiments. The L1 operation can include radio link monitoring (RLM) operations, beam failure detection (BFD) operations, candidate beam detection (CBD) operations, L1-RSRP measurements, and/or L1-SINR measurements, as various possibilities. As one possibility, when collision (e.g., in time domain) occurs between a gap and L1 operation, a UE can always cancel the gap and perform the L1 operation. As another possibility, priority can be introduced for L1operation (potentially including different priorities for different L1 operations), and a UE can either drop the gap or drop the L1 operation according to their relative priority. As a still further possibility, sharing between gaps and L1 operations can be introduced, and managed by configuring sharing factors for gaps and L1 operations. Such sharing factors can be managed in any of a variety of possible ways. As one option, one sharing factor can be configured for all types of gaps and one sharing factor can be configured for all types of L1 operations. As another option, different sharing factors can be configured for different types of gaps and one sharing factor can be configured for all types of L1 operations. As still another option, one sharing factor can be configured for all types of gaps and different sharing factors can be configured for different types of L1 operations. As a further option, different sharing factors can be configured for different types of gaps and different sharing factors can be configured for different types of L1 operations. Note that different types of gaps can refer to gaps configured for different functionalities. Partner ID can also be used to indicate gap type, in some instances.

In the following further exemplary embodiments are provided.

One set of embodiments can include a method, comprising: by a wireless device: establishing a wireless link with a cellular base station; providing wireless device capability information indicating measurement gap handling capability for the wireless device; and receiving measurement gap configuration information from the cellular base station, wherein the measurement gap configuration information configures one or more measurement gaps for the wireless device.

According to some embodiments, the wireless device capability information indicating measurement gap handling capability for the wireless device indicates a supported maximum number of active measurement gaps for the wireless device.

According to some embodiments, the wireless device capability information indicating measurement gap handling capability for the wireless device indicates a preferred maximum measurement gap length overhead of active measurement gaps for the wireless device.

According to some embodiments, wherein the measurement gap configuration information indicates gap functionality associated with the one or more measurement gaps configured for the wireless device.

According to some embodiments, the method further comprises: providing wireless device capability information to the cellular base station indicating that the wireless device supports associating gap functionality with measurement gaps.

According to some embodiments, the method further comprises: providing wireless device capability information to the cellular base station indicating one or more types of gap functionality that the wireless device supports associating with measurement gaps.

According to some embodiments, the measurement gap configuration information associates multiple gap functionalities with a measurement gap pattern for the wireless device.

According to some embodiments, the measurement gap configuration information associates a gap functionality with multiple measurement gap patterns for the wireless device.

According to some embodiments, the measurement gap configuration information configures at least a first measurement gap pattern associated with a first gap functionality and a second measurement gap pattern associated with a second gap functionality, wherein the first measurement gap pattern and the second measurement gap pattern are at least partially overlapping, wherein the method further comprises: determining whether to prioritize the first gap functionality or the second gap functionality during occasions when a measurement gap in the first measurement gap pattern and a measurement gap in the second measurement gap pattern are at least partially overlapping.

According to some embodiments, the method further comprises: receiving measurement gap functionality priority information from the cellular base station, wherein whether to prioritize the first gap functionality or the second gap functionality during occasions when a measurement gap in the first measurement gap pattern and a measurement gap in the second measurement gap pattern are at least partially overlapping is based at least in part on the measurement gap functionality priority information received from the cellular base station.

According to some embodiments, the method further comprises: receiving measurement gap functionality sharing factor information from the cellular base station, wherein whether to prioritize the first gap functionality or the second gap functionality during occasions when a measurement gap in the first measurement gap pattern and a measurement gap in the second measurement gap pattern are at least partially overlapping is based at least in part on the measurement gap functionality sharing factor information received from the cellular base station.

According to some embodiments, the method further comprises: determining that a layer one operation conflicts with a measurement gap configured by the measurement gap configuration information; and determining whether to prioritize the layer one operation or the measurement gap configured by the measurement gap configuration information.

Another set of embodiments can include a wireless device, comprising: one or more processors; and a memory having instructions stored thereon, which when executed by the one or more processors, perform steps of the method of any of the preceding examples.

Yet another set of embodiments can include a method, comprising: by a cellular base station: receiving wireless device capability information indicating gap handling capability for the wireless device, wherein the wireless device capability information indicates one or more of: a supported maximum number of active gaps for the wireless device; or a preferred maximum gap length overhead for the wireless device; and providing gap configuration information to the wireless device, wherein the gap configuration information configures one or more gaps for the wireless device.

According to some embodiments, the method further comprises: receiving wireless device capability information from the wireless device indicating that the wireless device supports associating functionality with gaps, wherein the gap configuration information indicates functionality associated with the one or more gaps configured for the wireless device.

According to some embodiments, the gap configuration information associates one or more of: multiple gap functionalities with a gap pattern; or a gap functionality with multiple gap patterns.

According to some embodiments, the method further comprises: providing gap functionality priority information to the wireless device, wherein the gap functionality priority information is configured for use for determining a gap functionality to perform during a gap that is shared between multiple gap functionalities.

According to some embodiments, the method further comprises: providing gap functionality sharing factor information to the wireless device, wherein the gap functionality sharing factor information is configured for use for determining a gap functionality to perform during a gap that is shared between multiple gap functionalities.

Still another set of embodiments can include a cellular base station, comprising: one or more processors; and a memory having instructions stored thereon, which when executed by the one or more processors, perform steps of the method of any of the preceding examples.

A further set of embodiments can include a computer program product, comprising computer instructions which, when executed by one or more processors, perform steps of the method of any of any of the preceding examples.

Another exemplary embodiment can include a device, comprising: an antenna; a radio coupled to the antenna; and a processing element operably coupled to the radio, wherein the device is configured to implement any or all parts of the preceding examples.

A further exemplary set of embodiments can include a non-transitory computer accessible memory medium comprising program instructions which, when executed at a device, cause the device to implement any or all parts of any of the preceding examples.

A still further exemplary set of embodiments can include a computer program comprising instructions for performing any or all parts of any of the preceding examples.

Yet another exemplary set of embodiments can include an apparatus comprising means for performing any or all of the elements of any of the preceding examples.

Still another exemplary set of embodiments can include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) can be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure can be realized in any of various forms. For example, in some embodiments, the present subject matter can be realized as a computer-implemented method, a computer-readable memory medium, or a computer system. In other embodiments, the present subject matter can be realized using one or more custom-designed hardware devices such as ASICs. In other embodiments, the present subject matter can be realized using one or more programmable hardware elements such as FPGAs.

In some embodiments, a non-transitory computer-readable memory medium (e.g., a non-transitory memory element) can be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) can be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
providing wireless device capability information indicating measurement gap handling capability for a wireless device; and
receiving measurement gap configuration information from a cellular base station, wherein the measurement gap configuration information configures one or more measurement gaps for the wireless device.

2. The method of claim 1,
wherein the wireless device capability information indicating measurement gap handling capability for the wireless device indicates a supported maximum number of active measurement gaps for the wireless device.

3. The method of claim 1,
wherein the wireless device capability information indicating measurement gap handling capability for the wireless device indicates a preferred maximum measurement gap length overhead of active measurement gaps for the wireless device.

4. The method of claim 1,
wherein the measurement gap configuration information indicates gap functionality associated with the one or more measurement gaps configured for the wireless device.

5. The method of claim 1, wherein the method further comprises:
providing wireless device capability information to the cellular base station indicating that the wireless device supports associating gap functionality with measurement gaps.

6. The method of claim 1, wherein the method further comprises:
providing wireless device capability information to the cellular base station indicating one or more types of gap functionality that the wireless device supports associating with measurement gaps.

7. The method of claim 1,
wherein the measurement gap configuration information associates multiple gap functionalities with a measurement gap pattern for the wireless device.

8. The method of claim 1,
wherein the measurement gap configuration information associates a gap functionality with multiple measurement gap patterns for the wireless device.

9. The method of claim 1,
wherein the measurement gap configuration information configures at least a first measurement gap pattern associated with a first gap functionality and a second measurement gap pattern associated with a second gap functionality, wherein the first measurement gap pattern and the second measurement gap pattern are at least partially overlapping, wherein the method further comprises:
determining whether to prioritize the first gap functionality or the second gap functionality during occasions when a measurement gap in the first measurement gap pattern and a measurement gap in the second measurement gap pattern are at least partially overlapping.

10. The method of claim 9, wherein the method further comprises:
receiving measurement gap functionality priority information from the cellular base station,
wherein whether to prioritize the first gap functionality or the second gap functionality during occasions when a measurement gap in the first measurement gap pattern and a measurement gap in the second measurement gap pattern are at least partially overlapping is based at least in part on the measurement gap functionality priority information received from the cellular base station.

11. The method of claim 9, wherein the method further comprises:
receiving measurement gap functionality sharing factor information from the cellular base station,
wherein whether to prioritize the first gap functionality or the second gap functionality during occasions when a measurement gap in the first measurement gap pattern and a measurement gap in the second measurement gap pattern are at least partially overlapping is based at least in part on the measurement gap functionality sharing factor information received from the cellular base station.

12. The method of claim 1, wherein the method further comprises:
determining that a layer one operation conflicts with a measurement gap configured by the measurement gap configuration information; and
determining whether to prioritize the layer one operation or the measurement gap configured by the measurement gap configuration information.

13. A method, comprising:
receiving wireless device capability information indicating gap handling capability for a wireless device, wherein the wireless device capability information indicates one or more of:
a supported maximum number of active gaps for the wireless device; or
a preferred maximum gap length overhead for the wireless device; and
providing gap configuration information to the wireless device, wherein the gap configuration information configures one or more gaps for the wireless device.

14. The method of claim 13, wherein the method further comprises:
receiving wireless device capability information from the wireless device indicating that the wireless device supports associating functionality with gaps,
wherein the gap configuration information indicates functionality associated with the one or more gaps configured for the wireless device.

15. The method of claim 13, wherein the gap configuration information associates one or more of:
multiple gap functionalities with a gap pattern; or
a gap functionality with multiple gap patterns.

16. The method of claim 13, wherein the method further comprises:
providing gap functionality priority information to the wireless device, wherein the gap functionality priority information is configured for use for determining a gap functionality to perform during a gap that is shared between multiple gap functionalities.

17. An apparatus, comprising:
a processor configured to, when executing instructions stored in a memory, perform operations comprising:
providing wireless device capability information indicating measurement gap handling capability for a wireless device; and
receiving measurement gap configuration information from a cellular base station, wherein the measurement gap configuration information configures one or more measurement gaps for the wireless device.

18. The apparatus of claim 17,
wherein the wireless device capability information indicating measurement gap handling capability for the wireless device indicates a supported maximum number of active measurement gaps for the wireless device.

19. The apparatus of claim 17,
wherein the wireless device capability information indicating measurement gap handling capability for the wireless device indicates a preferred maximum measurement gap length overhead of active measurement gaps for the wireless device.

20. The apparatus of claim 17, further comprising:
a radio operably coupled to the processor.
